(19) United States
(12) Patent Application Publication
(10) Pub. No.: US 2026/0260324 A1
(43) Pub. Date: Sep. 3, 2026

(54) METHODS FOR SYSTEM MONITORING AND ASSESSMENT

(71) Applicant: HITACHI, Ltd., Tokyo (JP)

(72) Inventors: Jie HU, Northville, MI (US); Nobutaka KIMURA, Yokohama (JP)

(21) Appl. No.: 19/067,467

(22) Filed: Feb. 28, 2025

(51) Int. Cl. G06T 7/00; B25J 19/00; G06T 1/00; G06T 7/70

(52) U.S. Cl. CPC G06T 7/0002; B25J 19/0066; G06T 1/0014; G06T 7/70; G06T 2207/20081; G06T 2207/20084

(57) ABSTRACT

A process monitoring system, the system comprising: one or more sensors; and a processor in communication with the one or more sensors, the processor is configured to: select a first system checkpoint for performing process monitoring on a robotic system; measure system variables using the one or more sensors at the first system checkpoint; capture one or more images of the robotic system using a vision sensor at the first system checkpoint; generate at least one prediction image of the robotic system using a prediction model with the system variables as input to the prediction model; and perform anomaly detection by comparing the one or more images of the robotic system against the at least one prediction image.

### BACKGROUND

### Field

The present disclosure is generally directed to methods and systems for performing process monitoring and anomaly detection.

In automation, it is important to monitor the status of a process and detect any anomalies, which is important for purposes such as evaluation of the system performance (e.g., throughput, success rate, etc.), improving the system design based on errors, preventing prolonged downtime caused by process errors, etc.

For example, in a robotic pick and place application, one might want to know whether the objects are being safely handled and transported. Unexpected events such as package dropping, package damaging, etc., may occur as packages are being manipulated during the process. These errors could further affect downstream operations. Thus, it is necessary to monitor the operation, including not only the conditions (e.g., functionality, appearance, etc.) but also the motions of the system components, to detect any anomalies.

While some status of a process can be measured and checked directly by using sensors (e.g., weight, temperature, etc.), others might not be measured directly, or may be difficult/expensive to measure using specialized sensors, such as the condition of the package, stability of grip in robotic material handling. When some statuses of a process/system are left unmonitored because they cannot be measured directly, process anomalies may be left undetected, which may cause significant downtime or damage to the system.

In the related art, a method for detecting robot anomalies through simulation image generation and comparison is disclosed. Complete operational plans/motions plans are required in order to produce the simulation image, which can be difficult to provide and burdensome in practice. Further, anomaly detection is limited to the robot and fails to take the environment in which the robot interacts with into consideration.

In the related art, a method for monitoring and detecting system/robot abnormality is disclosed. Images of the robot are captured while the robot is operating in a normal state, and compared against previously captured images of the robot. The method requires baseline images to be captured for purpose of comparison, which is rigid and has limited detection coverage.

### SUMMARY

Aspects of the present disclosure involve an innovative method for performing process monitoring. The method may include selecting, by a processor, a first system checkpoint for performing process monitoring on a system; measuring, by the processor, system variables using one or more sensors at the first system checkpoint; capturing, by the processor, one or more images of the system using a vision sensor at the first system checkpoint; generating, by the processor, at least one prediction image of the system using a prediction model with the system variables as input to the prediction model; and performing, by the processor, anomaly detection by comparing the one or more images of the system against the at least one prediction image.

In some example implementations, the system may comprise a robot arm configured to grasp and move an object.

In some example implementations, the system variables may comprise one or more of joint angles of the robot arm, a weight of the object, dimensions of the object, a Stock Keeping Unit (SKU) of the object, or a barcode of the object.

In some example implementations, the method may further include, for an anomaly being detected, automatically issuing, by the processor, instructions to the robot arm for performing a recovery process.

In some example implementations, the processor may be configured to select the first system checkpoint based on a pose of the robot arm or a location of the object.

In some example implementations, the one or more images captured using the vision sensor may comprise one or more images of the robot arm and/or the object at the first system checkpoint.

In some example implementations, the method may further comprise deriving, by the processor, relative location between the robot arm and the vision sensor using the one or more images of the system; and deriving, by the processor, joint angles of the robot arm using the one or more images of the system, wherein generating the at least one prediction image comprising using the relative location between the robot arm and the vision sensor and the joint angles of the robot arm as input to the prediction model to generate the at least one prediction image.

In some example implementations, the prediction model is an Artificial Intelligence (AI) model trained using historical system data comprising (i) historical joint angles of the robot arm; and (ii) historical motion images of the robot arm.

In some example implementations, the historical motion images of the robot arm may comprise two-dimensional motion images of the robot arm.

In some example implementations, the one or more images of the robotic system may comprise an image of the robot arm and an image of the object.

In some example implementations, the at least one prediction image of the robotic system may comprise a robot arm prediction image and an object prediction image.

In some example implementations, the processor may be configured to compare the one or more images of the robotic system against the at least one prediction image by comparing the image of the robot arm against the robot arm prediction image and comparing the image of the object against the object prediction image.

In some example implementations, the processor may be configured to select the first system checkpoint based on receipt of a sensor signal indicating a process transition.

Aspects of the present disclosure involve an innovative system for performing process monitoring. The system may include one or more sensors; and a processor in communication with the one or more sensors, the processor is configured to: select a first system checkpoint for performing process monitoring on a robotic system; measure system variables using the one or more sensors at the first system checkpoint; capture one or more images of the robotic system using a vision sensor at the first system checkpoint; generate at least one prediction image of the robotic system using a prediction model with the system variables as input to the prediction model; and perform anomaly detection by comparing the one or more images of the robotic system against the at least one prediction image.

In some example implementations, the robotic system may comprise a robot arm configured to grasp and move an object.

In some example implementations, the system variables may comprise one or more of joint angles of the robot arm, a weight of the object, dimensions of the object, a Stock Keeping Unit (SKU) of the object, or a barcode of the object.

In some example implementations, the processor may be further configured to, for an anomaly being detected, automatically issue instructions to the robot arm for performing a recovery process.

In some example implementations, the processor may be configured to select the first system checkpoint based on a pose of the robot arm or a location of the object.

In some example implementations, the one or more images captured using the vision sensor may comprise one or more images of the robot arm and/or the object at the first system checkpoint.

In some example implementations, the processor may be further configured to: derive relative location between the robot arm and the vision sensor using the one or more images of the robotic system; and derive joint angles of the robot arm using the one or more images of the robotic system, wherein generating the at least one prediction image comprising using the relative location between the robot arm and the vision sensor and the joint angles of the robot arm as input to the prediction model to generate the at least one prediction image.

In some example implementations, the prediction model may be an Artificial Intelligence (AI) model trained using historical system data comprising (i) historical joint angles of the robot arm; and (ii) historical motion images of the robot arm.

In some example implementations, the historical motion images of the robot arm may comprise two-dimensional motion images of the robot arm.

In some example implementations, the one or more images of the robotic system may comprise an image of the robot arm and an image of the object.

In some example implementations, the at least one prediction image of the robotic system may comprise a robot arm prediction image and an object prediction image.

In some example implementations, the processor may be configured to compare the one or more images of the robotic system against the at least one prediction image by comparing the image of the robot arm against the robot arm prediction image and comparing the image of the object against the object prediction image.

In some example implementations, the processor may be configured to select the first system checkpoint based on receipt of a sensor signal indicating a process transition.

Aspects of the present disclosure involve an innovative non-transitory computer readable medium, storing instructions for performing process monitoring. The instructions may include selecting a first system checkpoint for performing process monitoring on a system; measuring system variables using one or more sensors at the first system checkpoint; capturing one or more images of the system using a vision sensor at the first system checkpoint; generating at least one prediction image of the system using a prediction model with the system variables as input to the prediction model; and performing anomaly detection by comparing the one or more images of the system against the at least one prediction image.

In some example implementations, the system may comprise a robot arm configured to grasp and move an object.

In some example implementations, the system variables may comprise one or more of joint angles of the robot arm, a weight of the object, dimensions of the object, a Stock Keeping Unit (SKU) of the object, or a barcode of the object.

In some example implementations, the instructions may further include, for an anomaly being detected, automatically issuing, by the processor, instructions to the robot arm for performing a recovery process.

In some example implementations, the instructions may further include selecting the first system checkpoint based on a pose of the robot arm or a location of the object.

In some example implementations, the one or more images captured using the vision sensor may comprise one or more images of the robot arm and/or the object at the first system checkpoint.

In some example implementations, the instructions may further include deriving, by the processor, relative location between the robot arm and the vision sensor using the one or more images of the system; and deriving, by the processor, joint angles of the robot arm using the one or more images of the system, wherein generating the at least one prediction image comprising using the relative location between the robot arm and the vision sensor and the joint angles of the robot arm as input to the prediction model to generate the at least one prediction image.

In some example implementations, the prediction model is an Artificial Intelligence (AI) model trained using historical system data comprising (i) historical joint angles of the robot arm; and (ii) historical motion images of the robot arm.

In some example implementations, the historical motion images of the robot arm may comprise two-dimensional motion images of the robot arm.

In some example implementations, the one or more images of the robotic system may comprise an image of the robot arm and an image of the object.

In some example implementations, the at least one prediction image of the robotic system may comprise a robot arm prediction image and an object prediction image.

In some example implementations, the instructions may further include comparing the one or more images of the robotic system against the at least one prediction image by comparing the image of the robot arm against the robot arm prediction image and comparing the image of the object against the object prediction image.

In some example implementations, the instructions may further include selecting the first system checkpoint based on receipt of a sensor signal indicating a process transition.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates an example system component diagram 100 for performing process assessment and monitoring, in accordance with an example implementation.

FIG. 2 illustrates example checkpoints selected based on robot pose, in accordance with an example implementation.

FIG. 3 illustrates example checkpoints selected based on sensor signals.

FIG. 4 illustrates example images captured at various checkpoints.

FIG. 5 illustrates an example prediction image generation process 500 utilizing a mathematical model, in accordance with an example implementation.

FIG. 6 illustrates an example 3D robot motion visualization 600, in accordance with an example implementations.

FIG. 7 illustrates an example process 700 for training a machine learning model that generates prediction images, in accordance with an example implementation.

FIG. 8 illustrates an example process flow 800 for training a machine learning model that generates prediction images/2D motion images, in accordance with an example implementation.

FIG. 9 illustrates an example process flow 900 for generating 2D motion images using the trained machine learning model 860 of FIG. 8, in accordance with an example implementation.

FIG. 10 illustrates an example diagram 1000 showing how a prediction image is compared against a captured image, in accordance with an example implementation.

FIG. 11 illustrates an example diagram 1100 showing how image comparison is performed, in accordance with an example implementation.

FIG. 12 illustrates an alternate example system component diagram 1200 for performing process assessment and monitoring, in accordance with an example implementation.

FIG. 13 illustrates an example computing environment with an example computer device suitable for use in some example implementations.

FIG. 14 illustrates an alternate example process 1400 for training a machine learning model that generates prediction images, in accordance with an example implementation.

FIG. 15 illustrates an alternate process flow 1500 for training a machine learning model that generates prediction images/2D motion images, in accordance with an example implementation.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

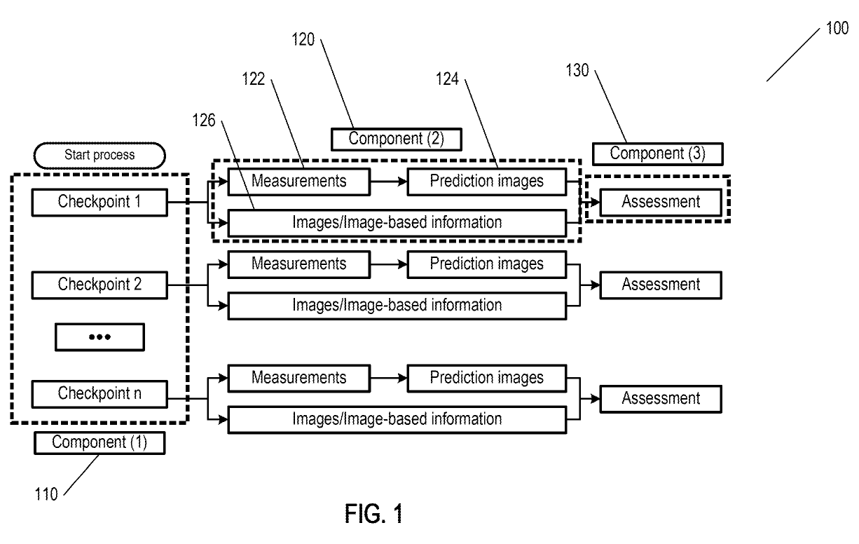

FIG. 1 illustrates an example system component diagram 100 for performing process assessment and monitoring, in accordance with an example implementation. As illustrated in FIG. 1, the system component diagram 100 may include a first component 110, a second component 120, a third component 130, etc. At the first component 110, checkpoints to be monitored are selected in an automation process. The selected checkpoint(s) correspond to one or more stages of a process that need to be checked to determine whether a process is in normal condition, to perform performance evaluation, etc.

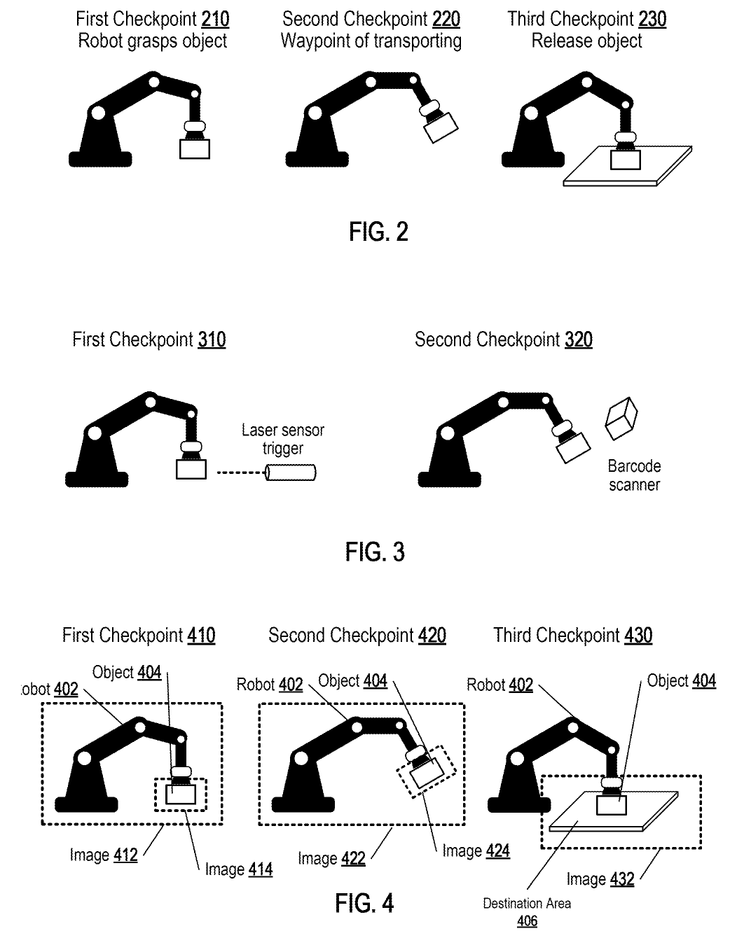

In some example implementations, one or more robots may be used to handle/manipulate objects. The checkpoint(s) can be selected based on one or more of robot poses, location of the object being manipulated, etc. For example, if the focus of monitoring is on the condition of the objects being handled/manipulated by the robot, one checkpoint could be when the object is first grasped by the robot; another checkpoint could be when the robot is releasing the object, etc. FIG. 2 illustrates example checkpoints selected based on robot pose, in accordance with an example implementation. Object grasping by the robot is set as the first checkpoint 210. Waypoint of object transportation is set as the second checkpoint 220. Object release is set as the third checkpoint 230. If the focus of monitoring is on the robot, then a plurality of robot poses can be selected as checkpoints.

In some example implementations, sensor signals may be used to set the checkpoints. Specifically, certain sensor signals indicating important transition points in the process may be received and used for checkpoint setting. For example, when a sensor signal indicates the process is going into the next phase (e.g., when a barcode scanner detects an object, when a proximity sensor detects an object, when a laser sensor reads certain value, etc.), and it is important to monitor if the transition proceeding as planned. Sensor used for generating the sensor signals may include, but not limited to, one or more of vision sensor (e.g., video camera, camera), Radio Frequency Identification (RFID) scanner, scanner, Quick-Response (QR) scanner, etc. FIG. 3 illustrates example checkpoints selected based on sensor signals. As illustrated in FIG. 3, data scanning/reading as performed by a laser sensor may be set as the first checkpoint 310, and barcode scanning may be set as the second checkpoint 320. In alternate example implementations, variables dependent on sensor measurements may be used to select the checkpoints. In some example implementations, the selection of checkpoints may come from or be made other management system/software such as, but not limited to, Warehouse Management System (WMS), Warehouse Execution System (WES), etc.

At the second component 120, specified system variables are measured (measurements 122) and specified images (images/image-based information 126) of the system components are captured for each checkpoint. The images may be captured using a vision sensor such as, but not limited to, a video camera, camera, mobile device, etc. In addition, prediction images 124 are generated based on the measurements 122. Measurements 122 include directly measurable system variables/easy-to-obtain signals such as, but not limited to, joint angles of a robot/robot arm, weight of the object being grasped by the robot, dimensions of the object, object barcode, Stock Keeping Unit (SKU) of the object, the Radio Frequency Identification (RFID) on the package of the object, etc., that may be obtained through one or more sensors (e.g., scanner, mobile device, scale, video camera, camera, etc.)

Images/image-based information 126 comprise information necessary to determine the condition and/or the motion of a system component. Such information may include, but not limited to, an image of the robot/robot arm grasping an object, an image of a sensor light, an image of a pallet containing the object(s) to be grasped, etc. FIG. 4 illustrates example images captured at various checkpoints. As illustrated in FIG. 4, images 412 and 414 may be taken at the first checkpoint 410. Image 412 is a complete image of a robot 402 and an object 404 being grasped by the robot 402. Image 414 contains only an image of the object 404. At the second checkpoint 420 (transporting phase), images 422 and 424 are captured. Image 422 contains the robot 402 and the object 404, and is taken during waypoint of transportation. Image 424 contains only an image of the object 404 taken during waypoint of transportation. At the third checkpoint 430 (release phase), an image 432 is captured. Image 432 contains an image of the object 404 and a destination area 406 where the object 404 is placed.

In some example implementations, regions of the systems where images are taken may be determined dynamically. For example, images of areas/regions with the most significant motions may be captured. The significant of motions can be velocity of an object in 3D space, along a monitored direction, or object motion visualized in 2D from a given camera view.

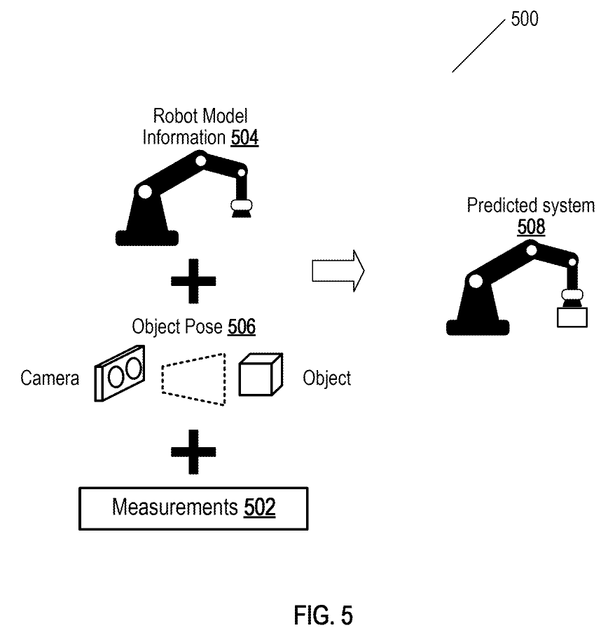

The prediction images 124 are image derived based on the measurements 122 to predict what the system (e.g., robot, environment, object, etc.) looks like under normal processing. This assumes that no failure or abnormality has occurred. The goal is to predict what the normal conditions look like if the process goes as planned. In some example implementations, the prediction performed using a mathematical model. FIG. 5 illustrates an example prediction image generation process 500 utilizing a mathematical model, in accordance with an example implementation. This is suitable for cases where all status to be checked can be predicted based linear mathematical relationships between the system components and the measurements. The benefit is that the computational cost is usually low. For example, given the measured robot joint angles (measurements 502), robot model information 504, and the recognized object pose 506, one could calculate what the system looks like when the object is grasped by the robot (predicted system 508).

In some example implementations, the digital models of the systems are generated and used in deriving the prediction images 124 by visualizing the system in 2D/3D. The prediction images 124 can be derived from the digital models after the models are updated using the measured system variables. For example, 3D and 2D visualizations of a robot arm would be available when the digital model of the robot arm exists. The 3D visualization of the robot arm would be available given the measured joint angles, and the 2D image of the robot arm is made available as captured by the camera. When packages/objects are placed on a pallet according to a planned order, the geometries of the pallet also can be predicted. Digital twins, which are exact copies of the physical systems, is another example of such digital models. The benefit of using digital models is that prediction images can be directly obtained.

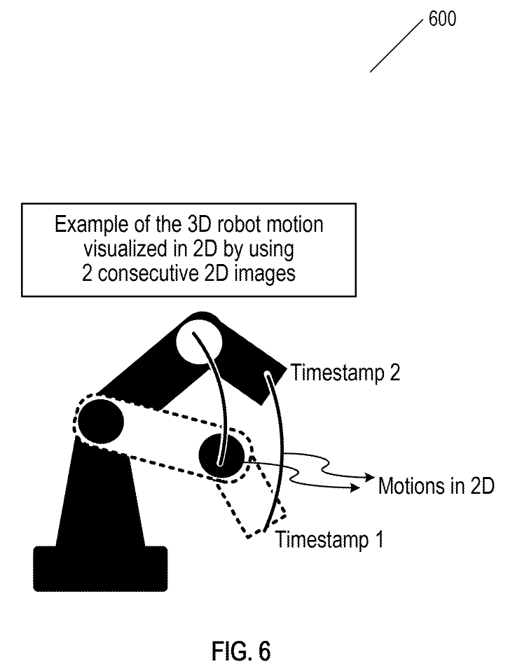

In some example implementations, 2D and 3D motions such as the motions of a (mobile or fixed) robot, the motions of objects being transported, or the combination of robot and object may be monitored. The 3D motions can be calculated using mathematical models of the system. FIG. 6 illustrates an example 3D robot motion visualization 600, in accordance with an example implementations. As illustrated in FIGS. 6, 3D motions of the robot arm may be visualized in 2D using optical flow. Specifically, the 3D motions can be predicted and represented using 2D images. The benefit of motion monitoring is that any anomalies in the process can be detected since the motions are continuous, comparing to discrete checkpoints.

In some example implementations, the prediction images 124 may be generated using a trained machine learning model. This is preferred for cases where explicit mathematical model for making predictions does not exist, or where making predictions using trained models is faster than adoption of mathematical model. Use of trained machine learning models provides additional flexibility when there are variations in the normal operations. For example, a robot might reach to different locations on a pallet to pick up objects, a trained machine learning model would be able to generate predictions that considers the variances in robot poses.

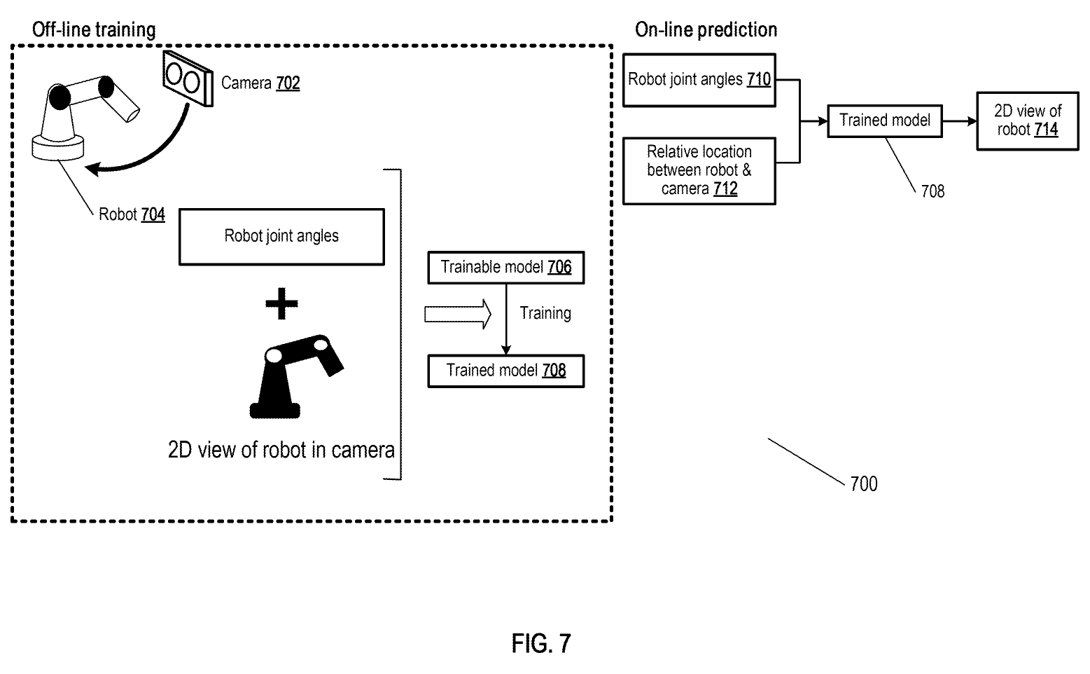

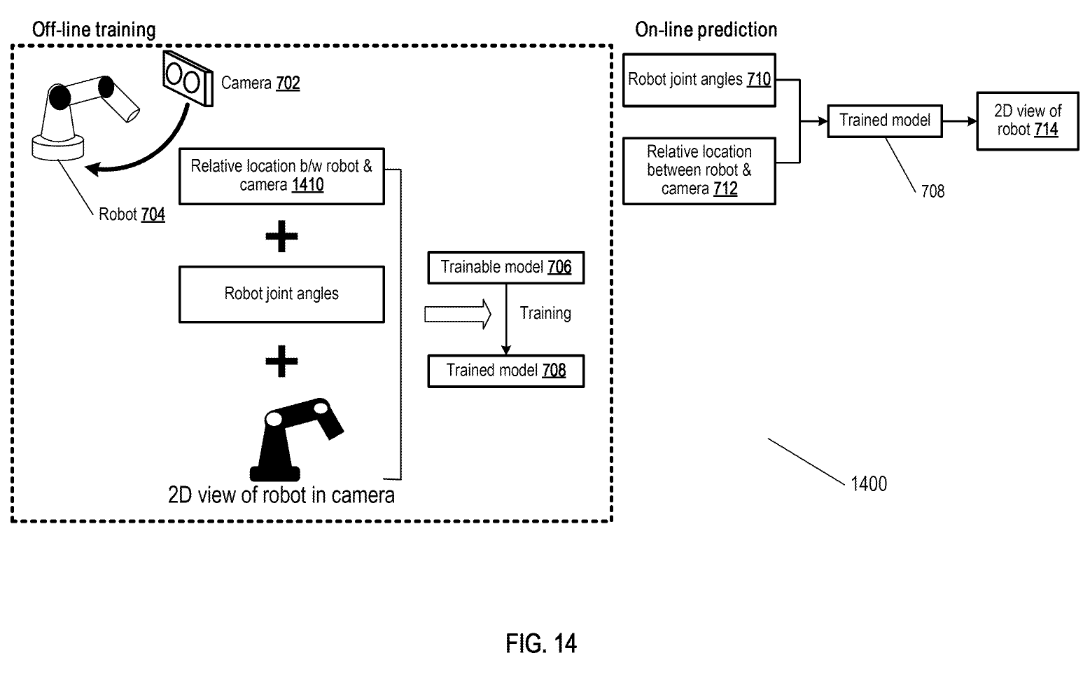

FIG. 7 illustrates an example process 700 for training a machine learning model that generates prediction images, in accordance with an example implementation. During off-line training phase, a trainable machine learning model 706 is trained using: (i) robot joint angles observed on robot 704; and (ii) 2D view of the robot 704 in camera 702. Once the trainable machine learning model 706 has been trained, a trained machine learning model 708 is generated. In some example implementations, the trainable machine learning model 706 is further trained using relative location between robot and camera. FIG. 14 illustrates an alternate example process 1400 for training a machine learning model that generates prediction images, in accordance with an example implementation. In some example implementations, the relative location between the robot and the camera 1410 may be determined through 3D motion capturing using the camera 702 on the robot 704.

The trainable machine learning model 706/trained machine learning model 708 may include, but not limited to, one or more Artificial Intelligence (AI)/Machine Learning (ML) model such as convolutional neural network (CNN), recurrent neural network (RNN), deep RNN (DRNN), Q-learning network (QN), deep Q-learning network (DQN), linear regression, decision trees, K-Nearest Neighbors, etc. RNN may include long short-term memory (LSTM), large language model (LLM), etc.

During the on-line prediction phase, current robot joint angles 710 and relative location between robot and camera 712 may be input to the trained machine learning model 708 to generate 2D views of the robot 714. The 2D views of the robot 714 (prediction images 124) are then compared against the actual views (images/image-based information 126) to identify any anomalies. Given that no 2D/3D digital models and visualization are required, required computational resources can be drastically reduced.

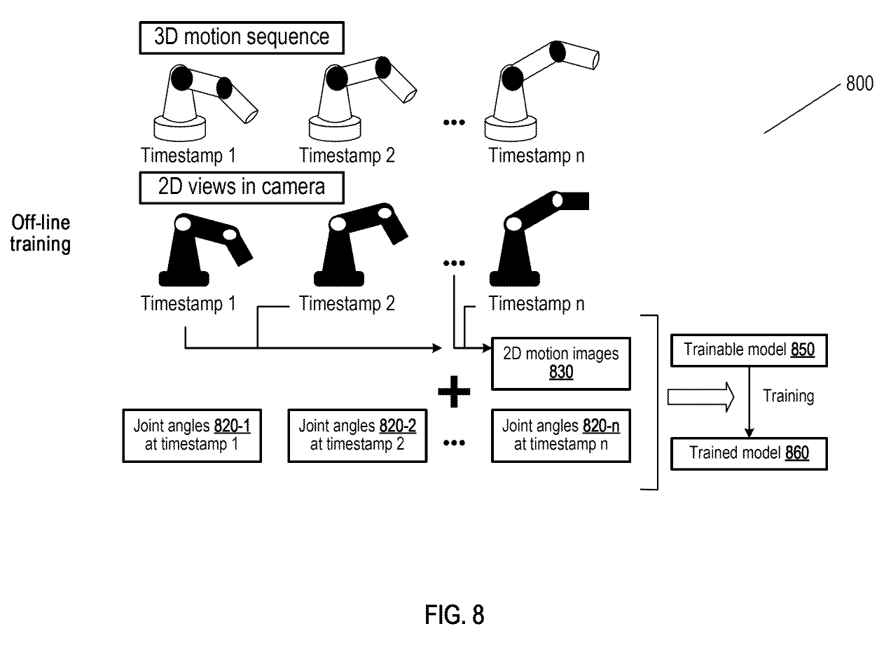

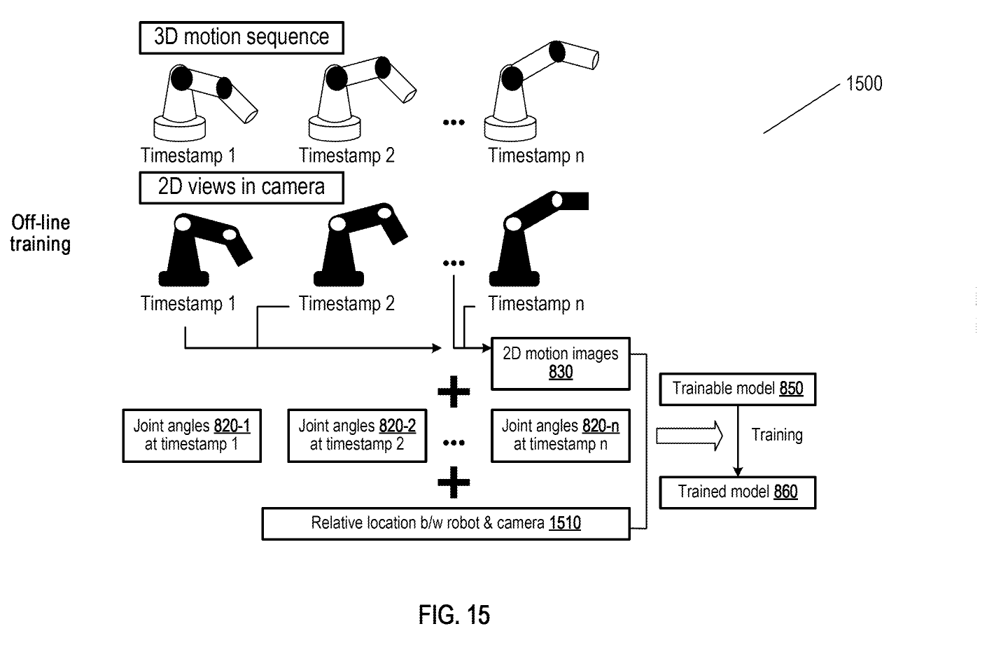

FIG. 8 illustrates an example process flow 800 for training a machine learning model that generates prediction images/2D motion images, in accordance with an example implementation. During off-line training phase, a trainable machine learning model 850 is trained using: (i) robot joint angles 820-1, 820-2 … 820-n; and (ii) 2D motion images 830 of the robot/system. In some example implementations, the trainable machine learning model 850 is further trained using relative location between robot and camera. FIG. 15 illustrates an alternate process flow 1500 for training a machine learning model that generates prediction images/2D motion images, in accordance with an example implementation. In some example implementations, the relative location between the robot and the camera 1510 may be determined through 3D motion capturing using a camera directed at the robot/system.

The robot joint angles 820-1 to 820-n and the 2D motion images 830 of the robot/system are captured/measured at various timestamps 1-n. In some example implementations, the 2D motion images 830 may be optical flow images. The 2D motion images 830 of the robot/system may be derived using 3D motion sequence of the robot/system captured at timestamps 1-n and/or 2D views of the robot/system taken at timestamps 1-n.

Once the trainable machine learning model 850 has been trained, a trained machine learning model 860 is generated, which generates 2D motion images of the robot/system as prediction images. The trainable machine learning model 850/trained machine learning model 860 may include, but not limited to, one or more Artificial Intelligence (AI)/Machine Learning (ML) model such as convolutional neural network (CNN), recurrent neural network (RNN), deep RNN (DRNN), Q-learning network (QN), deep Q-learning network (DQN), linear regression, decision trees, K-Nearest Neighbors, etc. RNN may include long short-term memory (LSTM), large language model (LLM), etc.

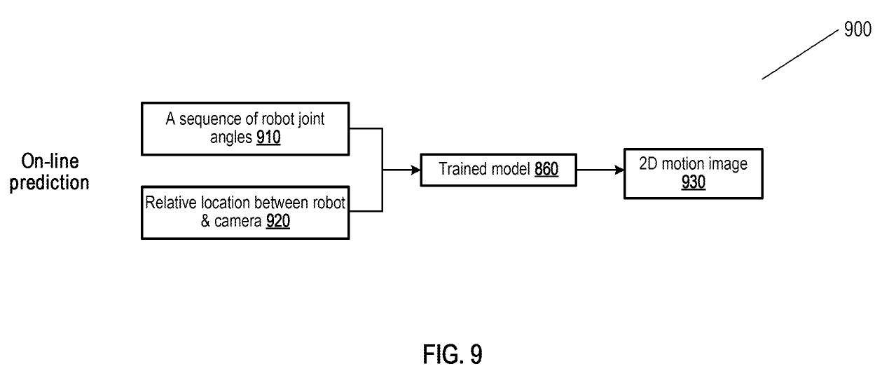

FIG. 9 illustrates an example process flow 900 for generating 2D motion images using the trained machine learning model 860 of FIG. 8, in accordance with an example implementation. During the on-line prediction phase, a sequence of robot joint angles 910 and relative location between robot and camera 920 may be input to the trained machine learning model 860 to generate predicted 2D motion images 930 (prediction images 124) are then compared against the actual views (images/image-based information 126) to identify any anomalies. Given that no 2D/3D digital models and visualization are required, required computational resources can be drastically reduced.

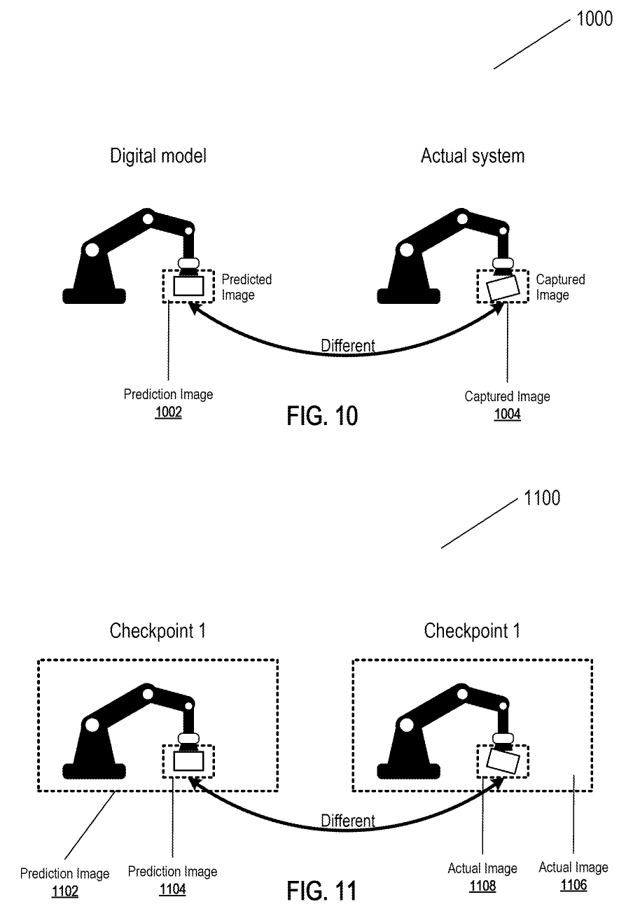

Referring back to FIG. 1, the third component 130 performs image assessment by comparing the images/image-based information 126 against the prediction images 124 to identify any anomalies. FIG. 10 illustrates an example diagram 1000 showing how a prediction image is compared against a captured image, in accordance with an example implementation. As illustrated in FIG. 10, a prediction image 1002 may be generated from a digital model, and compared against a captured image 1004 for anomaly detection. By comparing the prediction image 1002 against the captured image 1004, anomalies and irregularities may be detected in the process.

Anomalies such as, but not limited to, the motion of the machine/robot, object, the appearances of the object, etc., are detected when similarities between the prediction images 124 and the images/image-based information 126 are lower than a threshold (e.g., a preset percentage threshold, adjustable numeric threshold), or according to customized metrics.

FIG. 11 illustrates an example diagram 1100 showing how image comparison is performed, in accordance with an example implementation. As illustrated in FIG. 11, two prediction images 1102 and 1104 at checkpoint 1 may be generated based on received measurements, and compared against actual images 1106 and 1108 captured at checkpoint 1 for anomaly detection. Images 1102 and 1106 may contain the robot/complete system, and images 1104 and 1108 may be directed to the grasped object. By comparing the prediction images 1102 and 1104 against the captured images 1106 and 1108, anomalies and irregularities may be detected in the process.

In some example implementations, comparison is performed by directly comparing the image pixels. For example, if the images contain depth information, the depth of each pixel can be compared. If the images have multiple channels and include color information, each pixel from each channel of the image can be compared.

In some example implementations, the comparison is done by first transforming the images. For example, images may first be transformed/converted into vectors, and the similarities of vectors are used to represent the similarities of the images. In alternate example implementations, the images can also be converted into words that describe the images, then the descriptions of the images can be compared.

In some example implementations, the comparison is done using information extracted from images. For example, the distributions of the pixel values of two images can be compared, the robot/object motions visualized in 2D images can be compared (e.g., optical flow of images), etc.

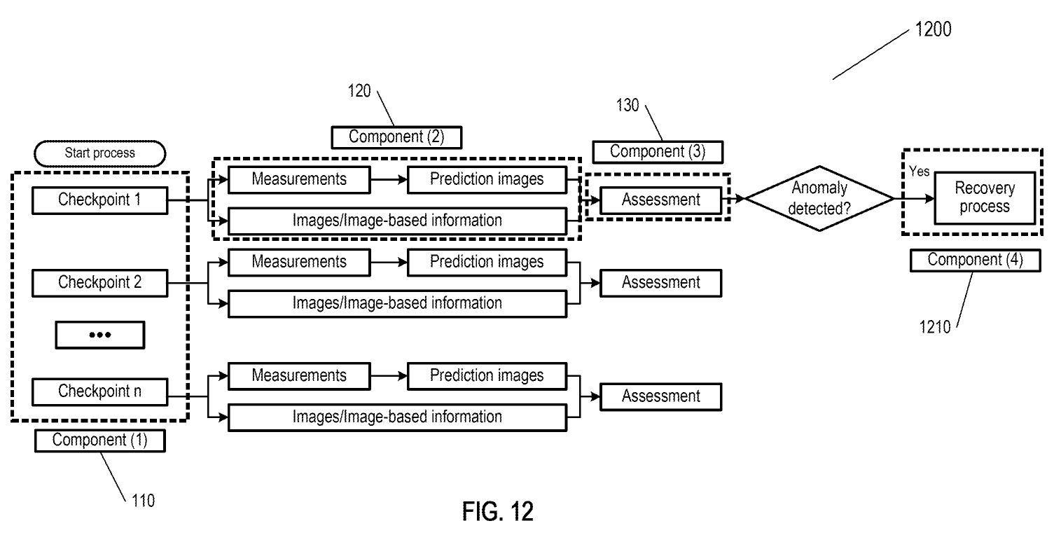

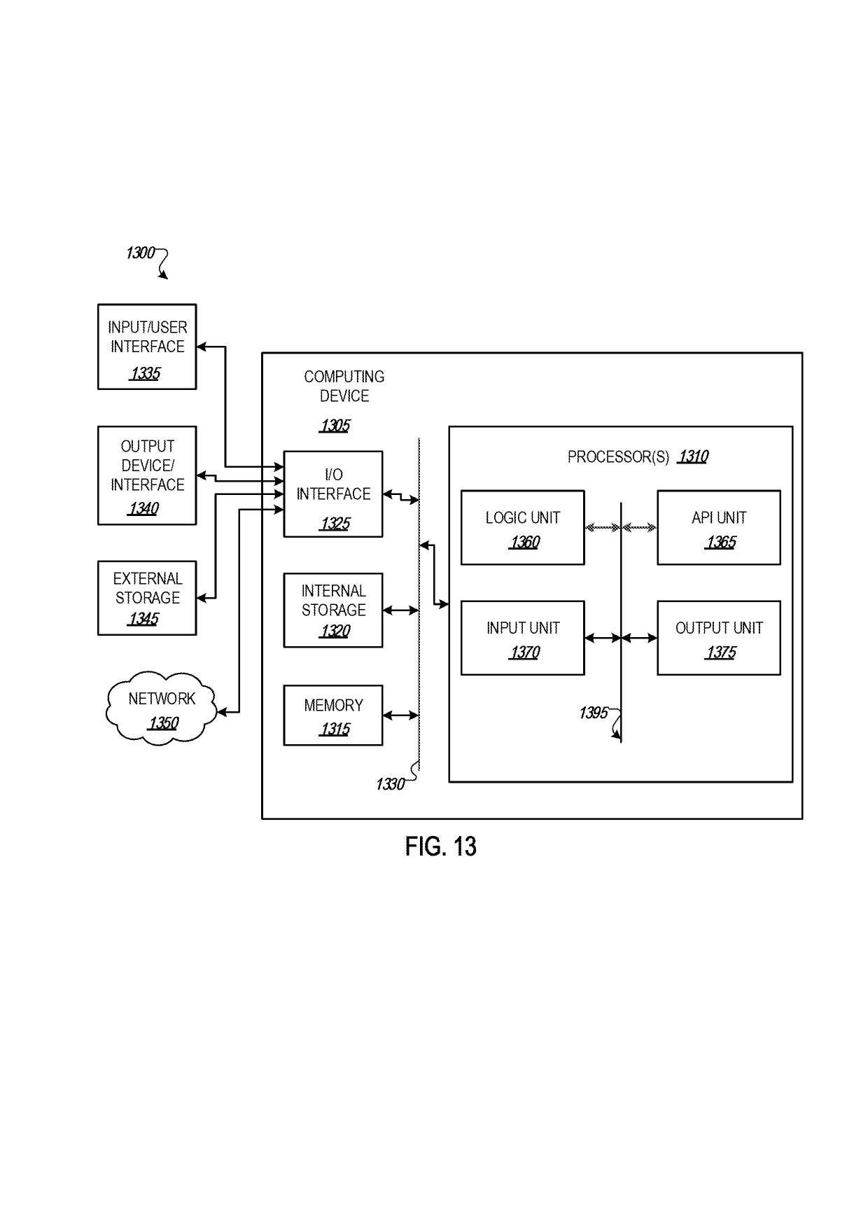

FIG. 12 illustrates an alternate example system component diagram 1200 for performing process assessment and monitoring, in accordance with an example implementation. As illustrated in FIG. 12, the system component diagram 1200 may include a first component 110, a second component 120, a third component 130, a fourth component 1210 etc. The first component 110, the second component 120, and the third component 130 are identified to those of FIG. 1. Once the assessment as performed by the third component 130 has been completed, a determination is then made to see whether an anomaly is present/has been detected. If an anomaly is present/detected, a recovery process is then performed, which corresponds to the fourth component 1210.

In some example implementations, the recovery process may be performed/initiated automatically without operator/human input. For example, the robot/robotic arm may be controlled to set a damaged object/package aside or to a specified location, reinitiate object grasping, pick up dropped object/package, etc. In alternate example implementations, the recovery process is performed with human assistance. For example, the operator may determine the best recovery process based on the information received from the system (e.g., alert). In some example implementations, an alert may be issued to an operator to notify the operator of the anomaly, and provide a recommended recovery action for the operator to review and execute.

The foregoing example implementation may have various benefits and advantages, such as an unconventional method for detecting system anomalies through prediction image generation and comparison against actual motions/images. The method provides an efficient solution to monitor process status that cannot be measured directly. In addition, anomalies can be detected timely to avoid prolonged downtime, damage to the system, quality issues, etc. Furthermore, recovery actions can be immediately performed (manually or automatically) without additional delays in the process.

FIG. 13 illustrates an example computing environment with an example computer device suitable for use in some example implementations. Computer device 1305 in computing environment 1300 can include one or more processing units, cores, or processors 1310, memory 1315 (e.g., RAM, ROM, and/or the like), internal storage 1320 (e.g., magnetic, optical, solid-state storage, and/or organic), and/or IO interface 1325, any of which can be coupled on a communication mechanism or bus 1330 for communicating information or embedded in the computer device 1305. IO interface 1325 is also configured to receive images from cameras or provide images to projectors or displays, depending on the desired implementation.

Computer device 1305 can be communicatively coupled to input/user interface 1335 and output device/interface 1340. Either one or both of the input/user interface 1335 and output device/interface 1340 can be a wired or wireless interface and can be detachable. Input/user interface 1335 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1340 may include a display, television, monitor, printer, speaker, braille, or the like. In some example implementations, input/user interface 1335 and output device/interface 1340 can be embedded with or physically coupled to the computer device 1305. In other example implementations, other computer devices may function as or provide the functions of input/user interface 1335 and output device/interface 1340 for a computer device 1305.

Examples of computer device 1305 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1305 can be communicatively coupled (e.g., via IO interface 1325) to external storage 1345 and network 1350 for communicating with any number of networked components, devices, and systems, including one or more computer devices of the same or different configuration. Computer device 1305 or any connected computer device can be functioning as, providing services of, or referred to as a server, client, thin server, general machine, special-purpose machine, or another label.

IO interface 1325 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 1300. Network 1350 can be any network or combination of networks (e.g., the Internet, local area network, wide area network, a telephonic network, a cellular network, satellite network, and the like).

Computer device 1305 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1305 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1310 can execute under any operating system (OS) (not shown), in a native or virtual environment. One or more applications can be deployed that include logic unit 1360, application programming interface (API) unit 1365, input unit 1370, output unit 1375, and inter-unit communication mechanism 1395 for the different units to communicate with each other, with the OS, and with other applications (not shown). The described units and elements can be varied in design, function, configuration, or implementation and are not limited to the descriptions provided. Processor(s) 1310 can be in the form of hardware processors such as central processing units (CPUs) or in a combination of hardware and software units.

In some example implementations, when information or an execution instruction is received by API unit 1365, it may be communicated to one or more other units (e.g., logic unit 1360, input unit 1370, output unit 1375). In some instances, logic unit 1360 may be configured to control the information flow among the units and direct the services provided by API unit 1365, the input unit 1370, the output unit 1375, in some example implementations described above. For example, the flow of one or more processes or implementations may be controlled by logic unit 1360 alone or in conjunction with API unit 1365. The input unit 1370 may be configured to obtain input for the calculations described in the example implementations, and the output unit 1375 may be configured to provide an output based on the calculations described in example implementations.

Processor(s) 1310 can be configured to select a first system checkpoint for performing process monitoring on a robotic system as shown in FIGS. 1 and 7 to 8. The processor(s) 1310 may also be configured to measure system variables using the one or more sensors at the first system checkpoint as shown in FIGS. 1 and 7 to 8. The processor(s) 1310 may also be configured to capture one or more images of the robotic system using a vision sensor at the first system checkpoint as shown in FIGS. 1 and 7 to 8. The processor(s) 1310 may also be configured to generate at least one prediction image of the robotic system using a prediction model with the system variables as input to the prediction model as shown in FIGS. 1 and 7 to 8. The processor(s) 1310 may also be configured to perform anomaly detection by comparing the one or more images of the robotic system against the at least one prediction image as shown in FIGS. 1 and 7 to 8.

Processor(s) 1310 can be configured to, for an anomaly being detected, automatically issue instructions to the robot arm for performing a recovery process as shown in FIG. 12. Processor(s) 1310 can be configured to select the first system checkpoint based on a pose of the robot arm or a location of the object as shown in FIGS. 1 and 7 to 8.

Processor(s) 1310 can be configured to derive relative location between the robot arm and the vision sensor using the one or more images of the robotic system as shown in FIGS. 6-8. Processor(s) 1310 can be configured to derive joint angles of the robot arm using the one or more images of the robotic system as shown in FIGS. 6-8. Processor(s) 1310 can be configured to select the first system checkpoint based on receipt of a sensor signal indicating a process transition as shown in FIG. 3.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system’s registers and memories into other data similarly represented as physical quantities within the computer system’s memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A process monitoring system, the system comprising:
one or more sensors; and
a processor in communication with the one or more sensors, the processor is configured to:
select a first system checkpoint for performing process monitoring on a robotic system;
measure system variables using the one or more sensors at the first system checkpoint;
capture one or more images of the robotic system using a vision sensor at the first system checkpoint;
generate at least one prediction image of the robotic system using a prediction model with the system variables as input to the prediction model; and
perform anomaly detection by comparing the one or more images of the robotic system against the at least one prediction image.

2. The system of claim 1,
wherein the robotic system comprises a robot arm configured to grasp and move an object,
wherein the system variables comprise one or more of joint angles of the robot arm, a weight of the object, dimensions of the object, a Stock Keeping Unit (SKU) of the object, or a barcode of the object.

3. The system of claim 2, wherein the processor is further configured to:
for an anomaly being detected, automatically issue instructions to the robot arm for performing a recovery process.

4. The system of claim 2, wherein the processor is configured to select the first system checkpoint based on a pose of the robot arm or a location of the object.

5. The system of claim 2, wherein the one or more images captured using the vision sensor comprise one or more images of the robot arm and/or the object at the first system checkpoint.

6. The system of claim 2, wherein the processor is further configured to:
derive relative location between the robot arm and the vision sensor using the one or more images of the robotic system; and
derive joint angles of the robot arm using the one or more images of the robotic system,
wherein generating the at least one prediction image comprising using the relative location between the robot arm and the vision sensor and the joint angles of the robot arm as input to the prediction model to generate the at least one prediction image.

7. The system of claim 6, wherein the prediction model is an Artificial Intelligence (AI) model trained using historical system data comprising (i) historical joint angles of the robot arm; and (ii) historical motion images of the robot arm.

8. The system of claim 7, wherein the historical motion images of the robot arm comprise two-dimensional motion images of the robot arm.

9. The system of claim 2,
wherein the one or more images of the robotic system comprise an image of the robot arm and an image of the object;
wherein the at least one prediction image of the robotic system comprises a robot arm prediction image and an object prediction image; and
wherein the comparing the one or more images of the robotic system against the at least one prediction image comprises comparing the image of the robot arm against the robot arm prediction image and comparing the image of the object against the object prediction image.

10. The system of claim 1, wherein the processor is configured to select the first system checkpoint based on receipt of a sensor signal indicating a process transition.

11. A process monitoring method, the method comprising:
selecting, by a processor, a first system checkpoint for performing process monitoring on a system;
measuring, by the processor, system variables using one or more sensors at the first system checkpoint;
capturing, by the processor, one or more images of the system using a vision sensor at the first system checkpoint;
generating, by the processor, at least one prediction image of the system using a prediction model with the system variables as input to the prediction model; and
performing, by the processor, anomaly detection by comparing the one or more images of the system against the at least one prediction image.

12. The method of claim 11,
wherein the system comprises a robot arm configured to grasp and move an object,
wherein the system variables comprise one or more of joint angles of the robot arm, a weight of the object, dimensions of the object, a Stock Keeping Unit (SKU) of the object, or a barcode of the object.

13. The method of claim 12, further comprising:
for an anomaly being detected, automatically issuing, by the processor, instructions to the robot arm for performing a recovery process.

14. The method of claim 12, wherein the processor is configured to select the first system checkpoint based on a pose of the robot arm or a location of the object.

15. The method of claim 12, wherein the one or more images captured using the vision sensor comprise one or more images of the robot arm and/or the object at the first system checkpoint.

16. The method of claim 12, further comprising:
deriving, by the processor, relative location between the robot arm and the vision sensor using the one or more images of the system; and
deriving, by the processor, joint angles of the robot arm using the one or more images of the system,
wherein generating the at least one prediction image comprising using the relative location between the robot arm and the vision sensor and the joint angles of the robot arm as input to the prediction model to generate the at least one prediction image.

17. The method of claim 16, wherein the prediction model is an Artificial Intelligence (AI) model trained using historical system data comprising (i) historical joint angles of the robot arm; and (ii) historical motion images of the robot arm.

18. The method of claim 17, wherein the historical motion images of the robot arm comprise two-dimensional motion images of the robot arm.

19. The method of claim 12,
wherein the one or more images of the robotic system comprise an image of the robot arm and an image of the object;
wherein the at least one prediction image of the robotic system comprises a robot arm prediction image and an object prediction image; and
wherein the processor is configured to compare the one or more images of the robotic system against the at least one prediction image by comparing the image of the robot arm against the robot arm prediction image and comparing the image of the object against the object prediction image.

20. The method of claim 11, wherein the processor is configured to select the first system checkpoint based on receipt of a sensor signal indicating a process transition.
